(19) United States
(12) Patent Application Publication
(10) Pub. No.: US 2017/0119025 A1
(43) Pub. Date: May 4, 2017

(54) BEVERAGE AND METHOD OF PRODUCING THE BEVERAGE

(71) Applicants: Jan Janowski, Plymouth, MI (US); Ludwik Janowski, Plymouth, MI (US)

(72) Inventors: Jan Janowski, Plymouth, MI (US); Ludwik Janowski, Plymouth, MI (US)

(21) Appl. No.: 14/924,969

(22) Filed: Oct. 28, 2015

(51) Int. Cl. A23L 2/56

(52) U.S. Cl. CPC A23L 2/56; A23V 2002/00

(57) ABSTRACT

The method includes the steps of providing a container for preparing the beverage. Water is added to the container and is heated to a parboil or a boil. Afterwards, honey is added to the container. The ratio of honey to water is approximately 9 to 10 parts water to 1 part honey. Shortly thereafter, lemon juice and a cinnamon stick are added to the container. The contents of the container are brought to a boil or parboil. After all of the contents are mixed together, the contents of the container are brought to a boil for a period of time. Generally, the period of time for this boil is approximately 10 minutes. Thereafter, the contents of the container are allowed to cool after the period of time has expired.

### SUMMARY

The invention relates to an innovative soft drink product/beverage that can be consumed by children, teenagers, and adults. The beverage can be consumed by children, teenagers, and adults. This beverage may be made such that it is an original chemical free drink all 100% completely natural without artificial chemicals or preservatives. It can be produced as a mixer drink for adults who like to add alcohol to the mixer. It can also be made as an alcohol cooler beverage. It can also be made as an 80-100 proof vodka. This beverage can either be refrigerated or kept on shelves at room temperature.

The method for making a beverage disclosed in this summary includes several steps. The method may include the steps of providing a container for preparing the beverage. Water is added to the container and is heated to a parboil or a boil. Afterwards, honey is added to the container. The ratio of honey to water is approximately 9 to 10 parts water to 1 part honey.

Shortly thereafter, lemon juice and a cinnamon stick, such as a Ceylon cinnamon stick, are added to the container. The contents of the container are brought to a boil or parboil. After all of the contents are mixed together, the contents of the container are brought to a boil for a period of time. Generally, the period of time for this boil is approximately 10 minutes. Thereafter, the contents of the container are allowed to cool after the period of time has expired. Additional flavorant and/or alcohol may be added to the beverage.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 illustrates a system for making the beverage;

FIG. 2 illustrates a method for making the beverage;

FIG. 3 illustrates a method for bottling the beverage; and

FIG. 4 illustrates the bottles utilized to bottle the beverage.

### DETAILED DESCRIPTION

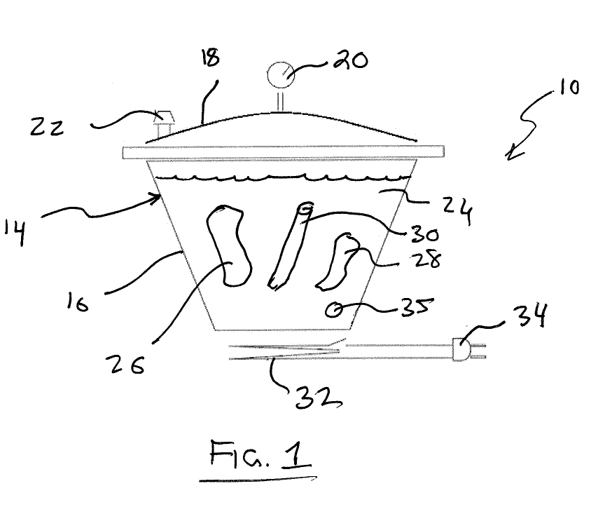

Referring to FIG. 1, a device 10 is shown for making the beverage 12. The device 10 may be a pressure cooker 14. The pressure cooker 14 has a container 16 as well as a lid 18. The lid 18 is configured so as to fixedly attach to the container 16 usually via a handle (not shown). By so doing, the pressure cooker 14 is able to cook the beverage 12 under pressure. The pressure of the pressure cooker 14 may be indicated by a pressure gauge 20. If the pressure of the pressure cooker 14 exceeds a certain threshold value, a pressure release valve 22 may release pressure from the pressure cooker 14.

As its primary components, the beverage 12 may include water 24, honey 26, lemon juice 28, and a cinnamon stick 30, such as a Ceylon cinnamon stick. The honey 26 may be all natural honey and the lemon juice may be derives from freshly squeezed lemons 28.

The pressure cooker may be heated by an electrical coil 32. The electrical coil receives power via a plug 34 which may be connected to a wall outlet. Of course, it should be understood that the container 16 may be any container capable of boiling a liquid. The heat source for this boiling may be any type of heat source, such as electric (as shown), gas, coal, charcoal, wood, or any other heat source.

In addition to these ingredients, other ingredients or flavorants 35 may be added such as fruit. The fruit may include any combination of fruit, such as blueberries, strawberries, raspberries, black berries, apples, peaches, oranges, etc. Of course, it should be understood that any type of flavorant may be utilized, not just fruit. Also, it should be understood that an alcoholic beverage can be added to the beverage as well. For example the alcoholic beverage may be vodka, whiskey, gin, etc.

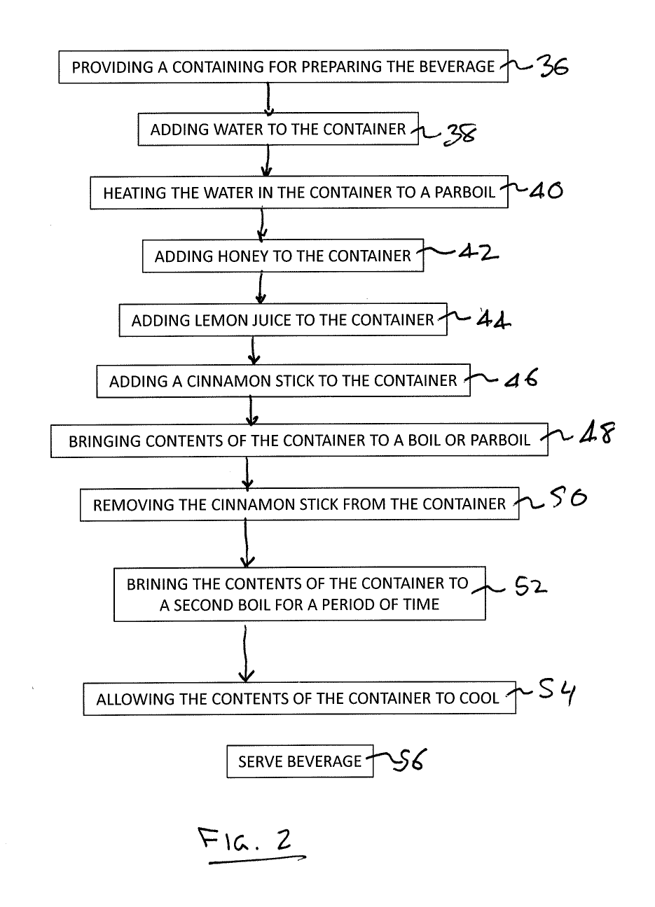

Referring to FIG. 2, a method for making the beverage is shown. Reference will also be made to FIG. 1 as well. In step 36, a container, such as the pressure cooker 14 is provided. In step 38, water 24 is added to the container or pressure cooker 14.

In step 40, the water 24 in the container or pressure cooker 14 is brought to a parboil or a boil. Around or at this moment, honey 26 is added to the container or pressure cooker 14, as indicated in step 42. Generally, the ratio of honey to water may be approximately 9 to 10 parts of water to 1 part honey. More specifically, the ration of honey to water may be approximately 9.6 parts of water to 1 part honey.

Thereafter, lemon juice 28 is added to the container or pressure cooker 14 in step 44. The lemon juice may be extracted from approximately 25-30 lemons. Generally, the ratio of water 24 to lemon juice 28 is approximately 200-300 parts of water to 1 part lemon juice. Additionally, a cinnamon stick 30 may be added to the contents as indicated in step 46. As stated before, other flavorants, such as fruit, may be added at this time.

The contents of the water 24, honey 26, and the lemon juice 28, and a cinnamon stick 30 and optionally other flavorants are brought to a boil or parboil, as indicated in step 48. Thereafter, as indicated in step 50, the cinnamon stick 30 is removed from the container or pressure cooker 14. From there, the contents of the container or pressure cooker 14 are brought to a second boil for a period of time, as indicated in step 52. The period of time can vary, but is generally approximately 10 minutes.

As indicated in step 54, the contents of the pressure cooker 14 or container is allowed to cool, wherein the beverage may be served, as indicated in step 56. The beverage may be served as a liquid. Also, alcohol may be added to the beverage as well. Further, the beverage could be frozen and served in a popsicle type form.

In one possible embodiment, the amount water 24 may be approximately 3 gallons. The amount of lemon juice 28 may be extracted for approximately 25-30 lemons. The amount of honey 26 may be approximately 40 ounces. As stated previously, the cinnamon stick 30 may be a single Ceylon cinnamon stick. The amount of honey 26 may be 40 ounces.

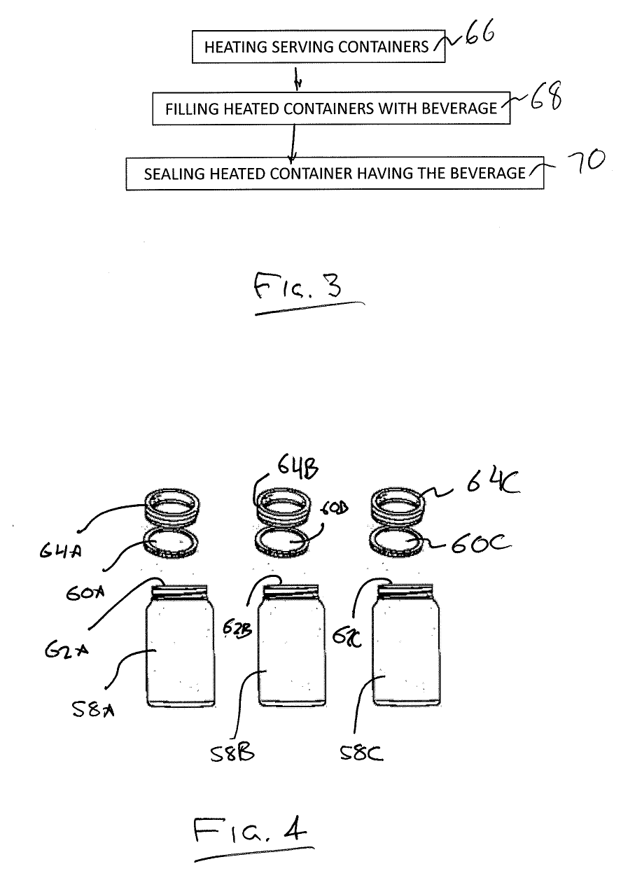

Referring to FIGS. 3 and 4, a method for bottling the beverage is shown. Referring more specifically to FIG. 4, bottles 58A, 58B, and 58C are shown. The bottles 58A, 58B, and 58C may have caps 60A, 60B, and 60C that are configured to mate with bottle tops 62A, 62B, and 62C. Screw tops 64A, 64B, and 64C are configured such that the bottle tops 60A, 60B, and 60C can be affixed to the bottle tops 62A, 62B, and 62C.

Referring more specifically to FIG. 3, the method begins with step 66 wherein the containers 58A, 58B, and 58C are heated. The containers may be heated to a temperature of 212 degrees Fahrenheit. The beverages provided to the containers 58A, 58B, and 58C are in step 68. Thereafter, the containers 58A, 58B, and 58C are sealed as shown in step 70. The sealing process involves providing the caps 60A, 60B, and 60C to the tops 62A, 62B, and 62C, respectively. From there, the screw tops 64A, 64B, and 64C are screwed on to the top of the containers 58A, 58B, and 58C as shown in step 70. As the beverage cools, a sealing action occurs. This sealing action allows the beverage to be stored for approximately 18 months.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

I/We claim:

1. A method for making a beverage, the method comprising the steps of:
providing a container for preparing the beverage;
adding water to the container;
heating the water in the container to a parboil;
adding honey to the container, wherein the ratio of honey to water is approximately nine to ten parts water to one part honey;
adding lemon juice to the container;
adding a cinnamon stick to the container;
bringing contents of the container to a first boil, wherein the first boil is a boil or a parboil;
brining the contents of the container to a second boil for a period of time, wherein the period of time of the second boil is approximately 10 minutes, wherein the second boil is a boil;
allowing the contents of the container to cool after the period of time for the second boil has expired.

2. The method of claim 1, wherein the ratio of honey to water is approximately 9.6 parts water to one part honey.

3. The method of claim 1, wherein the container is a pressure cooker and further comprising the step of sealing the pressure cooker when bringing contents of the container to the second boil for the period of time.

4. The method of claim 1, wherein the amount of water is approximately three gallons.

5. The method of claim 4, wherein the lemon juice is extracted from approximately 25 lemons.

6. The method of claim 4, wherein the amount of honey is approximately 40 ounces.

7. The method of claim 1, wherein the ratio of water to lemon juice is approximately 255 parts water to one part lemon juice.

8. The method of claim 1, further comprising the steps of:
heating serving containers to a temperature of 212 degrees Fahrenheit;
filling heated containers with cooled beverage;
sealing heated containers having the beverage; wherein a seal is formed as the heated containers cool.

9. The method of claim 1, further comprising the step of adding a flavorant to the container after the water has been heated to the first boil but before the second boil.

10. The method of claim 10, wherein the flavorant is a fruit flavorant.

11. The method of claim 1, further comprising the step of adding an alcoholic beverage to the beverage after the beverage has cooled.

12. The method of claim 1, further comprising the step removing the cinnamon stick after the first boil but before the second boil.
